(19) United States
(12) Patent Application Publication
(10) Pub. No.: US 2018/0212501 A1
(43) Pub. Date: Jul. 26, 2018

(54) LINE-START SINGLE-PHASE INDUCTION MOTOR

(71) Applicants: J. Rhett Mayor, Braselton, GA (US); S. Andrew Semidey, Woodstock, GA (US)

(72) Inventors: J. Rhett Mayor, Braselton, GA (US); S. Andrew Semidey, Woodstock, GA (US)

(21) Appl. No.: 15/879,759

(22) Filed: Jan. 25, 2018

Related U.S. Application Data
(60) Provisional application No. 62/450,551, filed on Jan. 25, 2017.

(51) Int. Cl. H02K 17/04; H02K 17/16

(52) U.S. Cl. CPC H02K 17/04; H02K 17/16

(57) ABSTRACT

There is a growing need for line-start single-phase electric motors that provide in combination high starting torque, high efficiency and low acoustic signature, particularly for use in hermetically sealed devices including, but not limited to, reciprocating piston systems for power generation and gas compression. This disclosure provides is a single-phase induction machine that meets this need.

### RELATED APPLICATION DATA

This application claims priority from U.S. Provisional Patent Application No. 62/450,551, which was filed on Jan. 25, 2017, which application is incorporated herein by reference in its entirety.

### FIELD

This disclosure pertains generally to single-phase electric machines, including, but not limited to, the design of the laminations to provide a preferred combination of high starting torque, high operating efficiency and increased stator structural rigidity for reduced acoustic noise.

### BACKGROUND

Appliances, lawn and garden power tools, air compressors, irrigation pumps, liquid transfer pumps, bilge and or sump pumps, and other residential and commercial applications, including without limitation heating, ventilation and air conditioning systems and refrigeration systems, have ubiquitously adopted the single-phase cage-rotor induction machine as the prime mover. However, due to strong societal and market demands for higher efficiency and increasing more powerful motors, conventional line-start single-phase induction machines are being replaced by inverter-fed three-phase AC induction motors or three-phase permanent magnet motors which are capable of increased efficiency and higher starting torque. These inverter-fed three-phase AC motors are disadvantageous due to the increased cost motor system resulting from the inclusion of the cost of the inverter and, in the case of permanent magnet machines, increased cost of the motor. What is needed is a single-phase line-start AC induction motor that is capable of high operating efficiency, high-starting torque, and low acoustic noise in fractional horsepower electric machines up to 5 horsepower, that is easy to manufacture and utilizing the least materials as possible thereby reducing the cost of the motor.

There is a need for single-phase alternating-current (AC) electric machines that provide in combination high starting torque and high efficiency and low acoustic signature, quiet particularly for use in hermetically sealed devices including, but not limited to, reciprocating piston systems for power generation and gas compression.

### SUMMARY

This disclosure provides a single-phase induction machine that provides such a design to meet the required combination of starting torque, operating efficiency and low acoustic signature. Other benefits of the disclosure herein will be understood by persons having ordinary skill in the art. Also understood by persons having ordinary skill in the art is that the disclosure herein is not limited in scope to the needs identified above. In one embodiment, the disclosure provides a single-phase induction motor including a stator, where the stator includes a plurality of stator teeth disposed radially about the inner diameter of the stator, with said stator teeth extending to the stator root diameter, a plurality of stator slots interposed between said stator teeth, and a stator yoke, extending from the stator root diameter to the stator outer diameter such that the modal frequencies of the stator structure do not coincide with the electromagnetic excitation frequencies of the stator winding. This embodiment also describes a rotor, where the rotor contains a first plurality of upper holes proximate to the rotor surface, a second plurality of lower holes in radial alignment with the first plurality and a flux shunt. The embodiment additionally provides a stator winding, comprising at least a first set of coils occupying at least a subset of said stator slots and at least a second set of coils occupying a subset of said stator slots, where the first set of coils is connected as to form the main winding and said second set of coils is connected as to form the auxiliary winding.

### BRIEF DESCRIPTION OF THE FIGURES

FIG. 1 presents a simplified front (axial) view of an induction machine with various components removed.

FIG. 2 presents a front view of the stator lamination of an induction machine.

FIG. 3 presents a detail view of a section of a stator lamination to provide more description of a stator slot geometry.

FIG. 4 presents a front view of the rotor lamination of an induction machine.

FIG. 5 presents a detail view of a section of a rotor lamination.

FIG. 6 presents two charts containing results from an electromagnetic finite element analysis.

FIG. 7 presents a diagram of a stator winding layout.

### DETAILED DESCRIPTION

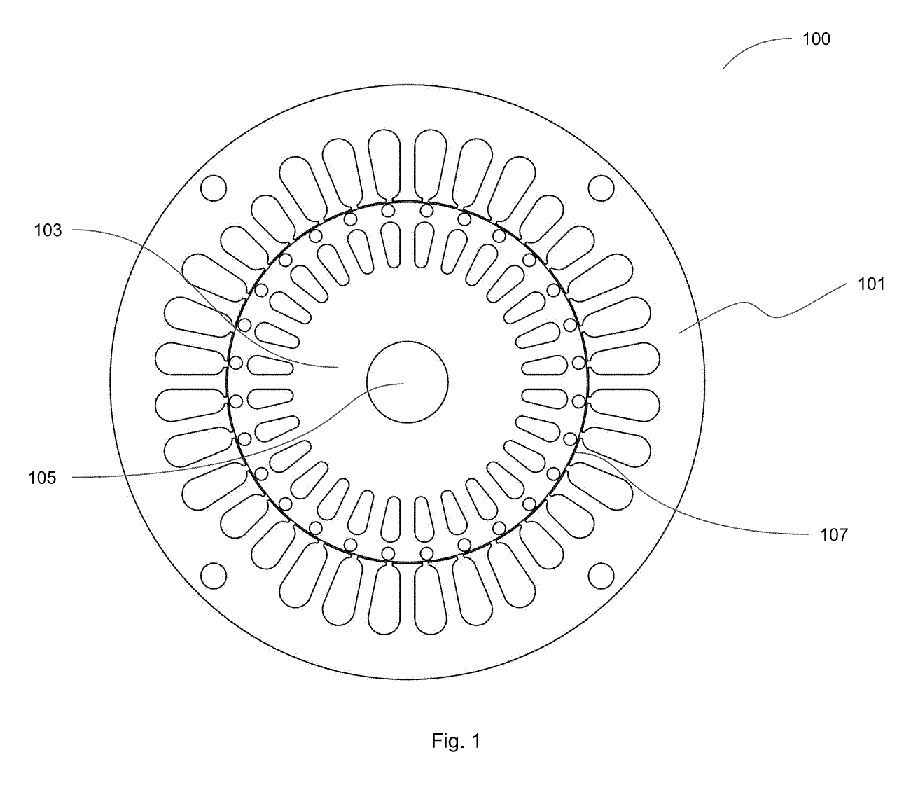

A line-start high-efficiency high-starting-torque and low acoustic noise single-phase four-pole AC induction motor is shown in the simplified front view presented in FIG. 1, from which various components, such as, without limitation, the stator windings and housing, have been omitted for ease of presentation. The induction motor 100 includes a laminated stator 101 and laminated rotor 103, both of novel electromagnetic design, and a shaft 105.

As will be explained in detail below, the design of the induction motor 100 includes at least the following key differences over conventional line-start induction motors: parallel sided stator tooth design with broad pole shoe, wherein the stator tooth width can be between substantially 38% and 42% of the slot pitch, dual-bar rotor design with a flux shunt of known width and radial position that maximize utilization of rotor steel and minimize reluctance during high-slip operation, optimum distribution of conductors per slot per phase, and a structurally-tuned stator such that the modal frequencies of the stator are out of phase with the excitation frequencies of the windings.

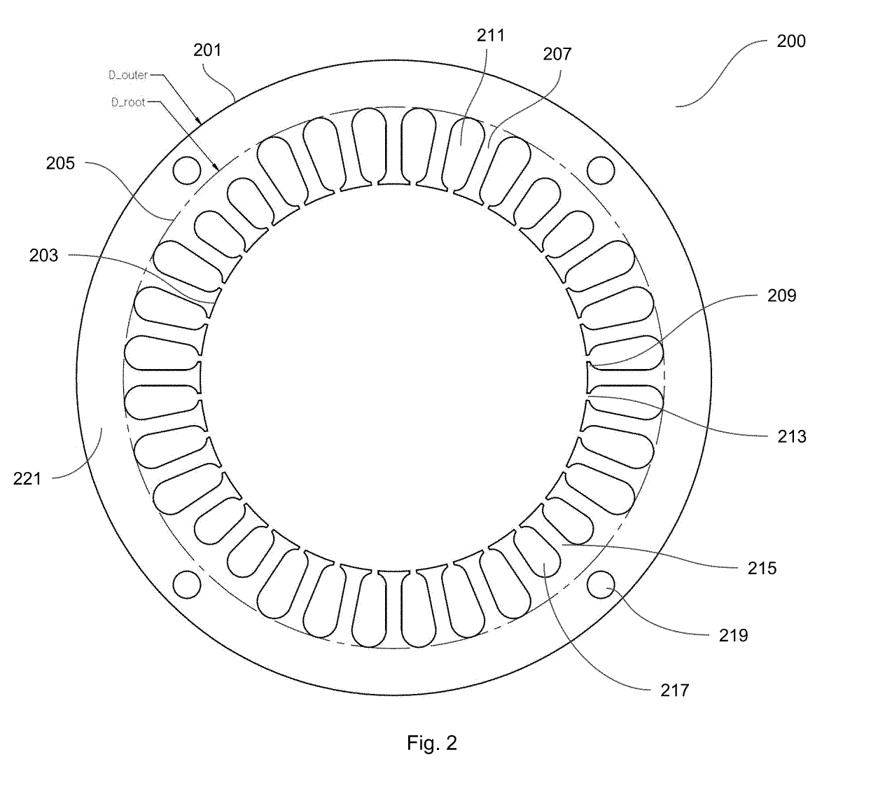

FIG. 2 presents a front view of a stator lamination 200 in accordance with an embodiment of this disclosure. The stator lamination having an outer diameter 201, D_outer, and an inner diameter 203 or stator bore, Dₛ, where the inner diameter is determined in accordance with standard electrical machine design practice as the summation of the necessary air gap diameter, D_{ag}, of the machine such that the motor meets the design requirements and the desired air gap, δ_{ag}; Dₛ=D_{ag}+δ_{ag}. The stator lamination 200 includes a plurality of stator teeth 207 (e.g., 32 stator teeth in the embodiment of FIG. 2) disposed radially around the inner diameter 203 of the stator, or stator bore, and extending from the inner diameter to the root diameter 205, D_root. The stator lamination 200 further includes a plurality of stator slots 211 disposed radially around the stator bore and adjacent to and between the stator teeth 207, wherein the current-carrying conductors of the stator windings are placed. Each stator tooth includes a broad pole shoe 209 so that each slot opening 213 to the stator slots is reduced to a minimum value. The minimization of the slot opening 213 substantially reduces harmonics in the electromagnetic field present in the air gap and the corresponding excitations in the stator windings, thereby contributing to the reductions in acoustic noise accomplished by the teachings in this disclosure.

The stator lamination 200 of the preferred embodiment, being a single-phase, line-start four-pole pole induction machine, includes four pairs of shorter stator teeth 215 and the associated four pairs of shortened stator slots 217 which house current-carrying conductors of the auxiliary winding of the stator windings. In addition, the embodiment includes four mounting holes 219 that are used to mechanically attach the stator to system to which is providing motive power.

The stator lamination 200 includes a region of stator back iron extending between the root diameter 205 and the outer diameter 201, commonly referred to as the stator yoke 221. The thickness of the stator yoke is defined by an optimal range of ratios of the root diameter 205 to the outer diameter 201 of the stator lamination 200. The acoustic noise signature of the motor, particularly when used in hermetically sealed applications, results from the coupling, or linking, of the electromagnetic excitation frequencies in the stator with the modal frequencies of the stator. The design in this disclosure, being different from conventional stator design, uniquely results in high dynamic stiffness of the stator structure at the excitation frequencies in the Maxwell forces imposed on the stator by the stator windings by the setting of the ratio of the root diameter to the outer diameter within the optimal range. Optimal phase margin, or separation between the structural frequency response spectrum and the electromagnetic excitation frequency spectrum, and minimum stator size, thereby also minimum stator mass, material and cost, can be accomplished when the ratio of the root diameter to the outer diameter is in the range of substantially no less than 0.825 and no more than 0.875. The present embodiment depicts a lamination design wherein this ratio is 0.85 and the resultant stator yoke thickness is 14 mm.

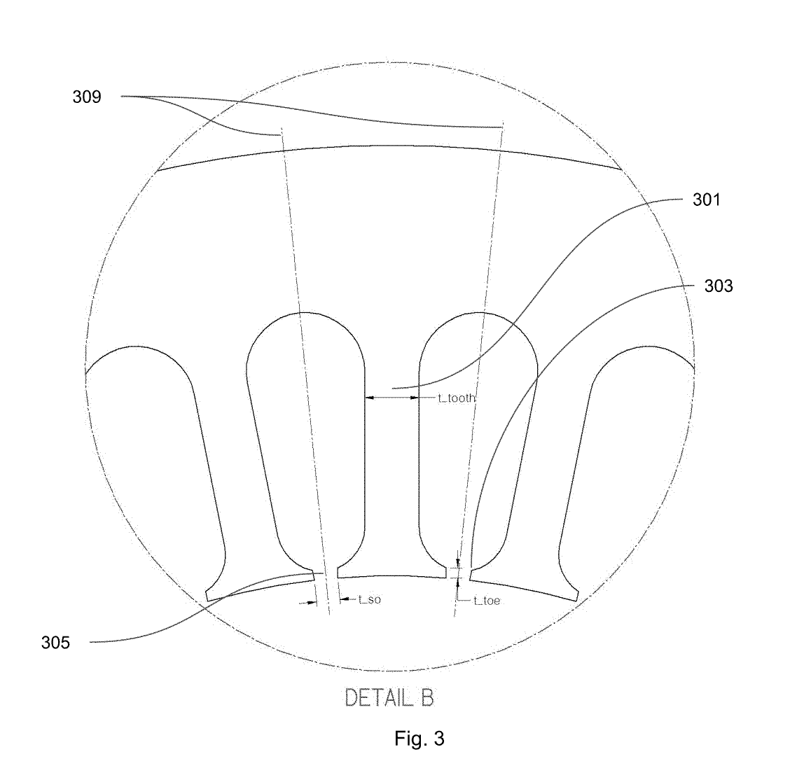

FIG. 3 presents a detail view of a region of the stator lamination 200 that provides additional description of the stator tooth and slot geometries. The stator teeth are of parallel sided design with a common tooth thickness 301, including a broad pole shoe with a specified toe thickness 303. The radial axii 309 translate through the center of two adjacent stator slots and describe the stator slot pitch, calculated as the circumference of the stator bore divided by the total number of stator teeth:

$${p}_{stator} = \frac{π {D}_{s}}{{N}_{s}} .$$

The common thickness 301 of the stator teeth in this disclosure is determined as a ratio of the stator slot pitch such that the magnetic utilization of the stator iron accomplishes, in combination, maximum saturation induction and minimum iron losses. In accordance with this embodiment, the common tooth thickness 301 of the stator teeth is defined to be between substantially 38% and 42% of the stator slot pitch. The thickness of the pole shoe 303, or toe-height, is determined by manufacturability considerations and can be maintained between substantially 0.75 mm to 1.25 mm in height. Similarly, the stator slot opening 305 is set to be no larger than 10% of the stator slot pitch. For specific embodiments, the slot opening 305 is minimized according to manufacturability considerations. The preferred embodiment adopts a slot opening of 1.9 mm, a common tooth thickness of 4 mm and a toe-height of 0.75 mm.

The stator lamination 200 may be produced from any electrical steel by any suitable manufacturing process, commonly, without limitation, stamping, blanking, or laser cutting. The laminated stator 101 then being manufactured by the stacking of a plurality of such stator lamination to a desired total stack height, or stack length, in accordance with the torque and power requirements of the motor. The preferred embodiment described herein depicts a circular cross section for the stator lamination 200, although certain embodiments may include other cross section shapes, or outer geometries, including without limitation, substantially circular cross sections with a plurality of lobes extending beyond the outer diameter, quadrilateral, hexagonal, octagonal and other such geometries as may be convenient for the specific embodiment.

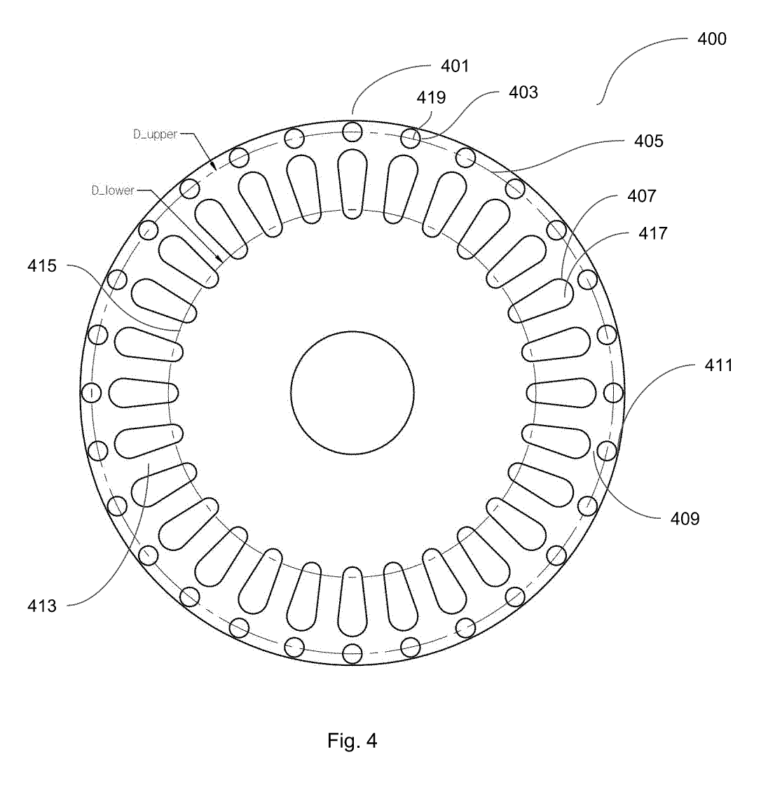

FIG. 4 presents a front view of an induction machine rotor with the end-rings, or shorting-rings, removed from the view to facilitate description. The rotor 400 is disposed within the inner diameter of the stator and concentrically aligned with said stator, has an outer diameter 401 determined in accordance with electrical machine design practice as the airgap diameter, defined above, subtracted by the width of the air gap: Dᵣ=D_{ag}−δ_{ag}. The rotor 400 includes a plurality of 28 upper holes 403, with the number of rotor holes being determined by a fixed ratio of 7:8 rotor holes to stator slots. The upper holes 403 of circular shape with known diameter are disposed radially within the outer diameter 401 of the rotor and proximate to the cylindrical outer surface of the rotor such that the center of the upper holes define an upper diameter 405, Dᵤₚₚₑᵣ, and that the entire upper hole remains contained within the outer diameter and leaving a outer retainment ring 411 of known width. The upper holes 403 house the current-carrying conductor, or conductors, of the upper rotor bar 423. The optimal location of the upper bar 423 for enhanced start torque and high efficiency is determined when the ratio of the upper diameter 405, Dᵤₚₚₑᵣ, to the rotor outer diameter 401 can be between substantially 0.94 and 0.96. The diameter of the upper holes 403 is determined as a fixed ratio of the outer diameter of the rotor such that the section area of the holes determines the electrical resistance of the outer rotor bar 423 of the induction rotor cage and such that the minimum current is utilized for the production of the magnetomotive force and associated flux distribution in the air gap for high starting torque and efficiency.

The rotor 400 further includes a plurality of lower holes 407 that are disposed radially below and in radial alignment with the upper holes 403. The lower holes are of non circular shape, described in detail below, and house the current-carrying conductor(s) of the lower bar 417 of the rotor. The lower holes are disposed radially below and in alignment with the upper holes such that the center of the minor arc 508 of each of the lower holes define a lower diameter 415, D_{lower}. The desired performance of high start torque, high efficiency and quiet operation is accomplished when the ratio of the lower diameter D_{lower} to the upper diameter Dᵤₚₚₑᵣ can be maintained between substantially 0.68 and 0.72. A portion of rotor iron, the flux shunt 409, remaining radially between the upper holes and lower holes of the rotor provides a parallel path for the rotor magnetic flux when operating under high-slip conditions such as start-up transients. The unique radial location and unique thickness of the flux shunt 409 enable the motors described in this disclosure to accomplish high-starting torque in combination with high efficiency due to the improvement in the flux linkage with the stator and minimization of the reluctance of the rotor path achieved by the flux shunt design.

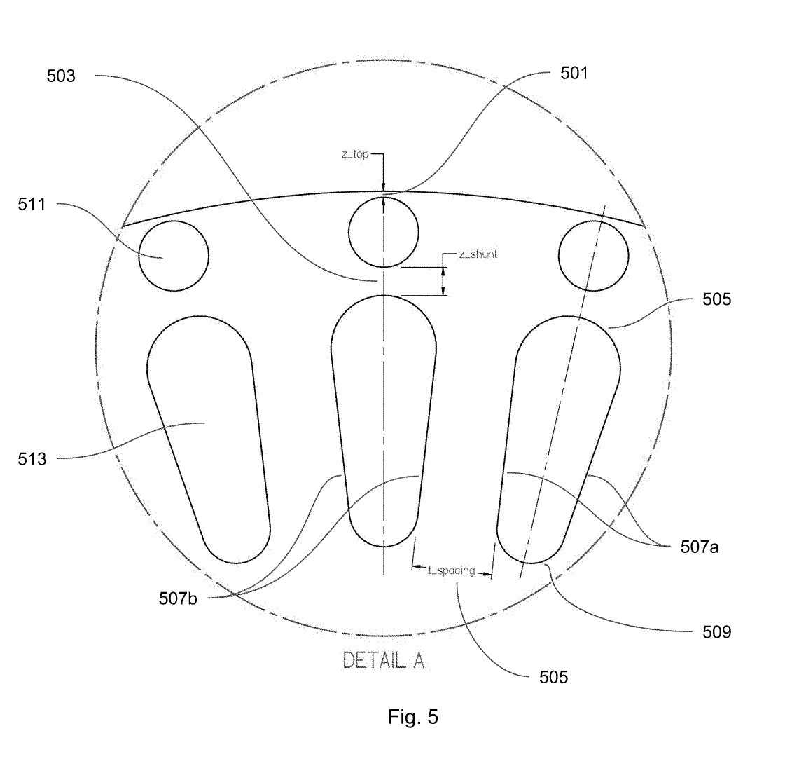

FIG. 5 presents a detail view of a region of the rotor 400 in order to facilitate further description of the geometry of the lower holes 513, the proximity 501, zₜₒₚ, of the upper hole 511 to the outer diameter of the rotor to the surface, the thickness, zₛₕᵤₙₜ, and location of the flux shunt 503 and the spacing 505, t_{spacing} between adjacent lower holes. The perimeter of the lower hole is defined by two arcs, a major arc 507 and minor arc 508, and two line segments 509 that are tangent to each of the major and minor arcs such that the adjacent line segments of 507a and 507b are parallel to each other and of common uniform normal distance establishing the spacing 505. The proximity 501, zₜₒₚ, to the outer diameter is determined by manufacturing considerations and can be between substantially 0.75 mm and 1.5 mm in tangent-normal distance between the upper hole and rotor outer radius. The thickness of the flux shunt 503 determines the reluctance of the rotor flux path during startup which is optimized when the thickness is set in proportion to the radial distance between the upper diameter, Dᵤₚₚₑᵣ, and the lower diameter, D_{lower}, to be between 0.26 and 0.28:

$$0.26 \leq \frac{2 {z}_{shunt}}{( {D}_{upper} - {D}_{lower} )} \leq 0.28 .$$

Maximum utilization of the steel and highest efficiency is accomplished when the ratio of the spacing, t_{spacing}, to the rotor lower bar pitch, calculated as the circumference of the lower diameter, D_{lower}, divided by the total number of rotor teeth:

$${p}_{rotor} = \frac{π {D}_{lower}}{{N}_{r}} ,$$

is between substantially 0.25 and 0.28.

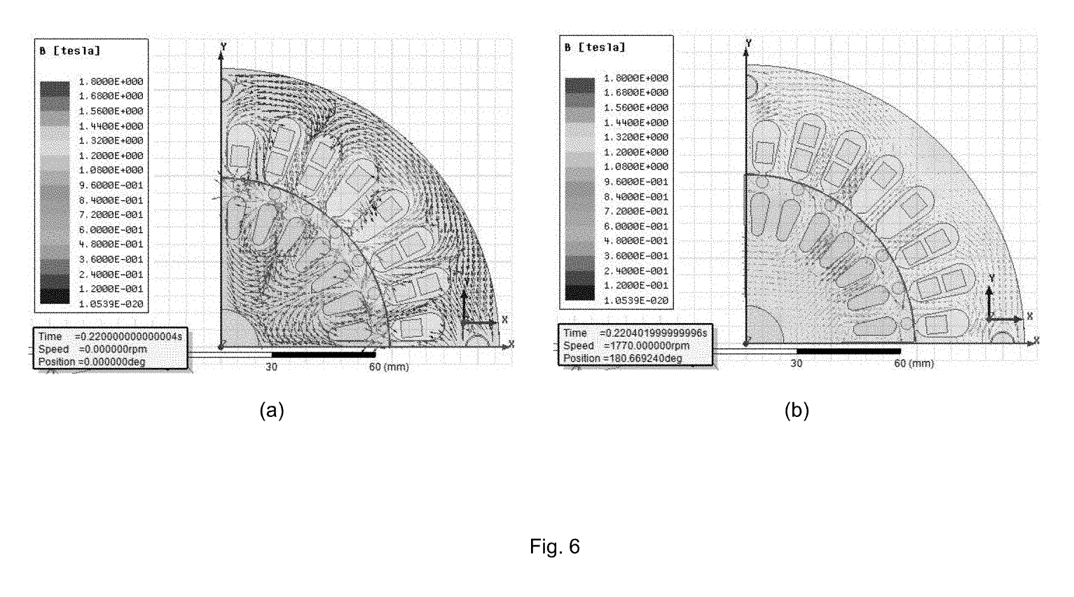

FIG. 6 presents two charts containing the flux vector field for preferred embodiments of this disclosure when operating under high-slip transients such as start-up conditions, in FIG. 6(a), and in normal operation, in FIG. 6(b), calculated by high-fidelity electromagnetic finite-element analysis. The flux density magnitudes and results presented in FIG. 6 and discussed herein and provided solely as illustrative and are not intended to be interpreted as limiting in any way. The main flux path of the motor under normal operation circumscribes the lower bar of the rotor and the spacing of the lower holes is such that the maximum utilization of the rotor steel is achieved, demonstrated by the flux density of 1.8 T which is the maximum flux density of the particular silicon steel used in the preferred embodiment. The main flux path of the motor under start-up circumscribes only the upper rotor bar and is clearly substantially shorter in length than that of normal operation and consequently of substantially lower reluctance. The lower reluctance of the magnetic circuit using the flux shunt requires substantially less magneto-motive force, and therefore substantially less rotor current, to drive the magnetic flux across the airgap, leading to enhance coupling with the stator and higher start-torque. The unique location and thickness of the rotor flux shunt provide for maximum utilization of the rotor steel is achieved, demonstrated by the flux density of 1.8 T which is the maximum flux density of the particular silicon steel used in the preferred embodiment.

In some embodiments the laminated rotor may be assembled such that individual rotor laminations are rotated with respect to each other in order to create an axial skewing of the rotor bars, both upper and lower, of some designed skew angle in order to reduce the magnitude of the harmonics in the electromagnetic field in the air gap resulting from the slotting effect of the stator slots on electromagnetic interactions between the rotor and the stator. The preferred embodiments of this disclosure adopt a 11.25° skew angle or a 5° skew angle.

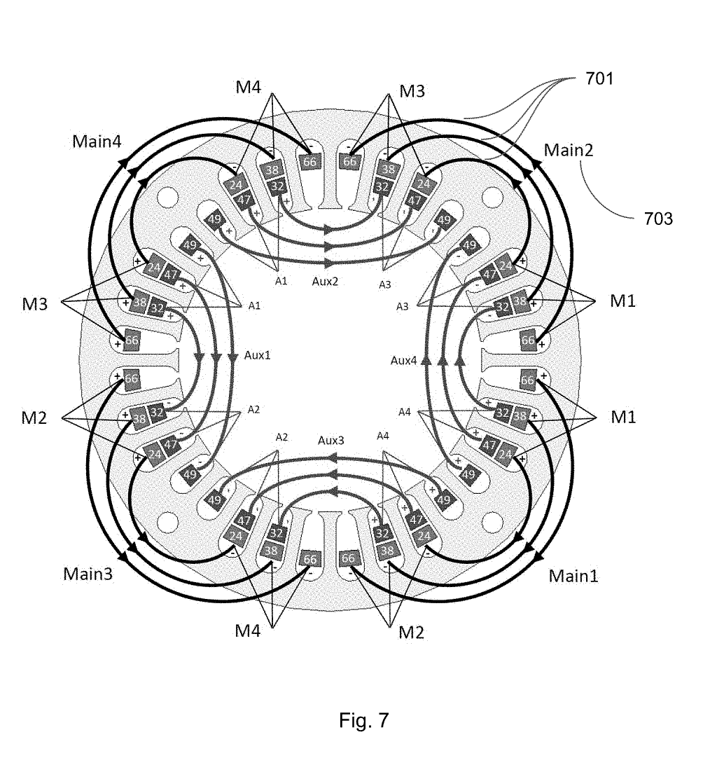

FIG. 7 presents an illustration of the winding layout demonstrating the optimal conductor distribution on the main and auxiliary windings of the four-pole preferred embodiment. The main winding includes three coils 701 per pole connected such that there are four coil groups 703 per phase, in accordance with common electrical machine design, housed in a subset of the stator slots that span one pole and adopts a unique and preferred distribution of the number of conductors per coil and similarly for the auxiliary winding. The unique distribution of conductors in the various stator slots for each coil group provides in combination, the high starting torque, high efficiency and low acoustic signature, in combination.

What is claimed is:

1. A single-phase induction motor comprising:
a stator having a plurality of stator teeth disposed radially about an inner diameter of the stator, the stator teeth extending from the inner diameter of the stator to a stator root diameter, a plurality of stator slots interposed between the stator teeth, and a stator yoke, extending from the stator root diameter to a stator outer diameter;
a stator winding, comprising at least a first set of coils occupying at least a first subset of the stator slots and at least a second set of coils occupying a second subset of the stator slots, wherein said first set of coils is connected to form the main winding and the second set of coils is connected to form the auxiliary winding.
a rotor, wherein the rotor contains a plurality of upper holes proximate to the rotor surface, a plurality of lower holes in radial alignment with the first plurality and a flux shunt;
wherein modal frequencies of the stator do not coincide with electromagnetic excitation frequencies of the stator winding.

2. The induction motor of 1, wherein a ratio of the stator root diameter to the stator outer diameter is no less than 0.825 and no more than 0.875.

3. The induction motor of claim 1, wherein a thickness of one or more of the stator teeth is defined between substantially 38 percent and 42 percent of a stator slot pitch.

4. The induction motor of claim 1, wherein at least one of the stator slots has an opening no larger than 10 percent of a stator slot pitch.

5. The induction motor of claim 1, wherein a ratio of upper holes of the rotor to stator slots is substantially 7 to 8.

6. The induction motor of claim 1, wherein the rotor defines an outer diameter and the upper holes of the rotor define an upper diameter, and wherein a ratio of the upper diameter to the outer diameter is substantially between 0.94 and 0.96.

7. The induction motor of claim 1, wherein the rotor defines an outer diameter and the upper holes of the rotor define an upper diameter, wherein the lower holes of the rotor define a lower diameter, and wherein a ratio of the lower diameter to the upper diameter is substantially between 0.68 and 0.72.

8. The induction motor of claim 1, wherein at least one stator tooth includes a pole shoe, wherein the pole shoe includes a toe, and wherein the toe has a thickness of substantially 0.75 mm to 1.25 mm.

9. The induction motor of claim 1, wherein the rotor comprises a plurality of rotor laminations, wherein the rotor laminations are rotated with respect to each other to create an axial skewing of bars of the rotor.

10. The induction motor of claim 9 wherein the axial skewing is at an angle of 11.25 degrees or 5 degrees.

11. A stator for an induction motor comprising:
a stator having a first plurality of stator teeth disposed radially about an inner diameter of the stator, the first plurality of stator teeth extending from the inner diameter of the stator to a stator root diameter, a plurality of stator slots interposed between the first plurality of stator teeth, and a stator yoke, extending from the stator root diameter to a stator outer diameter;
wherein a ratio of the stator root diameter to the stator outer diameter is no less than 0.825 and no more than 0.875.

12. The stator of claim 11 further comprising a second plurality of stator teeth, wherein the second plurality of stator teeth is shorter than the first plurality of stator teeth.

13. The stator of claim 11 wherein at least one of the first plurality of stator teeth includes a pole shoe, wherein the pole shoe includes a toe, and wherein the toe has a thickness of substantially 0.75 mm to 1.25 mm.

14. The stator of claim 11, wherein a thickness of one or more of the stator teeth is defined between substantially 38 percent and 42 percent of a stator slot pitch.

15. The stator of claim 11, wherein at least one of the stator slots has an opening no larger than 10 percent of a stator slot pitch.

16. A rotor for an induction motor comprising:
a rotor, wherein the rotor contains a plurality of upper holes proximate to the rotor surface, a plurality of lower holes in radial alignment with the first plurality and a flux shunt;
wherein the rotor defines an outer diameter and the upper holes of the rotor define an upper diameter, wherein the lower holes of the rotor define a lower diameter, and wherein a ratio of the lower diameter to the upper diameter is substantially between 0.68 and 0.72.

17. The rotor of claim 16 wherein the rotor defines an outer diameter, wherein a ratio of the upper diameter to the outer diameter is substantially between 0.94 and 0.96.

18. The rotor of claim 16, wherein the rotor comprises a plurality of rotor laminations, wherein the rotor laminations are rotated with respect to each other to create an axial skewing of bars of the rotor.

19. The rotor of claim 18 wherein the axial skewing is at an angle of 11.25 degrees or 5 degrees.

20. The rotor of claim 16 wherein the flux shunt extends radially between the upper holes and lower holes, and wherein a thickness of the flux shunt is proportional to the radial distance between the upper diameter and the lower diameter, and is configured to be between 0.26 and 0.28.

21. The rotor of claim 16 wherein the rotor comprises a plurality of rotor teeth, wherein a ratio of the lower diameter to the number of rotor teeth is between substantially 0.25 and 0.28.
